(19) United States
(12) Patent Application Publication
(10) Pub. No.: US 2026/0145523 A1
(43) Pub. Date: May 28, 2026

(54) VEHICLE CONTROLLER AND VEHICLE CONTROL METHOD THEREOF

(71) Applicants: HYUNDAI MOTOR COMPANY, SEOUL (KR); KIA CORPORATION, SEOUL (KR)

(72) Inventors: Yu Kyoung Sung, Hwaseong-si (KR); Joo Yean Kang, Hwaseong-si (KR); Chae Won Jeong, Hwaseong-si (KR)

(73) Assignees: HYUNDAI MOTOR COMPANY, SEOUL (KR); KIA CORPORATION, SEOUL (KR)

(21) Appl. No.: 19/321,899

(22) Filed: Sep. 8, 2025

(30) Foreign Application Priority Data
Nov. 25, 2024 (KR) 10-2024-0169248

(51) Int. Cl. B60K 35/28; B60K 35/65

(52) U.S. Cl. CPC B60K 35/28; B60K 35/65; B60K 2360/11; B60K 2360/1464; B60K 2360/592; B60K 2360/731

(57) ABSTRACT

A vehicle controller includes a user interface unit configured to display a menu screen including a plurality of audio/video/navigation/telematics (AVNT) menus and gesture cues, a memory configured to store one or more programs, and a processor configured to execute the program. When a passenger in a first vehicle logs in using a first profile, the processor may determine whether to display description of the gesture cues based on a gesture cue learning state stored after mapping with the first profile.

### CROSS-REFERENCE TO RELATED APPLICATION

This application claims priority to and the benefit of Korean Patent Application No. 10-2024-0169248, filed on Nov. 25, 2024, the disclosure of which is incorporated herein by reference in its entirety.

### BACKGROUND

### 1. Field

The present disclosure relates to a vehicle controller and a vehicle control method thereof, and more specifically, to a vehicle controller and a vehicle control method thereof, which selectively displays description of a gesture cue.

### 2. Discussion of Related Art

As display devices in vehicles become larger, a technology for recognizing gestures of passengers in a vehicle and providing various in-vehicle functions based on the recognized gestures has been commercialized.

However, as functions provided based on gestures become more diverse, drivers often do not recognize the presence of functions available based on gestures. For example, even when gesture cues indicating instructions using gestures are displayed on a display device, drivers sometimes do not know what a displayed gesture cue means or what function is operated by a gesture. Accordingly, the drivers cannot properly use various functions provided in the vehicle.

In addition, since the drivers do not know what function the cue displayed on the display device indicates, they learn the function indicated by the cue after making their gestures.

Accordingly, there is a need for improvement to increase the usability of conventional gesture-based cues.

### SUMMARY

The present disclosure is directed to providing a vehicle controller and a vehicle control method, which are capable of guiding a user to easily recognize and use a gesture cue executed based on the gesture.

Objects of the present disclosure are not limited to the above-described object, and other objects that are not mentioned will be able to be clearly understood by those skilled in the art to which the present disclosure pertains from the following description.

According to an aspect of the present disclosure, there is provided a vehicle controller including a user interface unit configured to display a menu screen including a plurality of menus and gesture cues, a memory configured to store one or more programs, and a processor configured to execute the program, wherein, when a passenger in a first vehicle logs in using a first profile, the processor determines whether to display description of the gesture cues based on a gesture cue learning state stored after mapping with the first profile.

When checking the gesture cue learning state and determining that a mode is a beginner mode, the processor may determine that the description of the gesture cues is displayed with the gesture cues on the menu screen.

When checking the gesture cue learning state and determining that the passenger logging in using the first profile has not met a learning condition which is set for the gesture cues, the processor may determine that the mode is the beginner mode.

When the passenger uses the gesture cues N_{TH} (N_{TH} is a natural number greater than or equal to 1) times or more, the processor may remove the description of the gesture cues displayed on the menu screen and may stop the beginner mode.

When checking the gesture cue learning state and determining that the mode is not the beginner mode, the processor may determine that the gesture cues without the description thereof are displayed on the menu screen.

When checking the gesture cue learning state and determining that the passenger logging in using the first profile has met a learning condition which is set for the gesture cues, the processor may determine that the mode is not the beginner mode.

When the passenger in the first logs in using a second profile, the processor may determine whether to display the description of the gesture cues based on a gesture cue learning state stored after mapping with the second profile.

When the passenger logs in using the first profile in a second vehicle, the second vehicle may determine whether to display the description of the gesture cues based on the gesture cue learning state stored after mapping with the first profile.

The processor may download the gesture cue learning state from a server.

According to another aspect of the present disclosure, there is provided a vehicle control method of a vehicle controller including a user interface unit, a memory configured to store one or more programs, and a processor configured to execute the program, which includes logging in, by a passenger in a first vehicle, using a first profile, determining whether to display description of gesture cues based on a gesture cue learning state stored after mapping with the first profile, and displaying a menu screen including a plurality of menus and gesture cues and selectively displaying the description of the gesture cues.

In the determining of whether to display the description of the gesture cues, when the gesture cue learning state is confirmed and it is determined that a mode is a beginner mode, it may be determined that the description of the gesture cues is displayed with the gesture cues on the menu screen.

In the determining of whether to display the description of the gesture cues, when the gesture cue learning state is confirmed and it is determined that the passenger logging in using the first profile has not met a learning condition which is set for the gesture cues, it may be determined that the mode is the beginner mode.

The vehicle control method may further include removing the description of the gesture cues displayed on the menu screen and stopping the beginner mode when the passenger uses the gesture cues N_{TH} (N_{TH} is a natural number greater than or equal to 1) times or more.

In the determining of whether to display the description of the gesture cues, when the gesture cue learning state is confirmed and it is determined that a mode is not a beginner mode, it may be determined that a gesture cues without the description thereof are displayed on the menu screen.

In the determining of whether to display the description of the gesture cues, when the gesture cue learning state is confirmed and it is determined that the passenger logging in using the first profile has met a learning condition which is set for the gesture cues, it may be determined that the mode is not the beginner mode.

The vehicle control method may further include determining whether to display the description of the gesture cues based on a gesture cue learning state stored after mapping with the second profile when the passenger in the first vehicle logs in using a second profile.

When the passenger logs in using the first profile in a second vehicle, the second vehicle determines whether to display the description of the gesture cues based on the gesture cue learning state stored after mapping with the first profile.

The vehicle control method may further include downloading the gesture cue learning state from a server.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating a vehicle control system according to an embodiment of the present disclosure;

FIG. 2 is a block diagram illustrating a first vehicle controller according to an embodiment of the present disclosure;

FIG. 3 is an exemplary view of a menu screen on which a first gesture cue and first description are displayed;

FIG. 4 is an exemplary view of a screen on which a menu or information corresponding to the first gesture cue is further displayed;

FIG. 5 is an exemplary view of a menu screen on which the first gesture cue is displayed in the case of no beginner mode;

FIG. 6 is an exemplary view of a menu screen on which a second gesture cue and second description are displayed;

FIG. 7 is a flowchart illustrating a vehicle control method of a first vehicle controller according to one embodiment of the present disclosure;

FIG. 8 is a flowchart illustrating a vehicle control method of a first vehicle controller according to one embodiment of the present disclosure; and

FIG. 9 is a flowchart illustrating a vehicle control method of a second vehicle controller according to one embodiment of the present disclosure.

### DETAILED DESCRIPTION

Hereinafter, embodiments of the present disclosure will be described in detail with reference to the accompanying drawings so that those skilled in the art to which the present disclosure pertains can easily carry out the present disclosure. However, the present disclosure may be implemented in various different forms and is not limited to embodiments described herein.

In describing embodiments of the present disclosure, when it is determined that the detailed description of known configurations or functions may obscure the gist of the present disclosure, detailed description thereof will be omitted. In addition, components irrelevant to the description of the present disclosure have been omitted from the drawings, and similar components have been denoted as similar reference numerals.

In the present disclosure, when a certain component is described as being “connected,” “coupled,” or “joined” to another component, it may include not only a direct connection relationship, but also an indirect connection relationship in which still another component is present therebetween. In addition, when a certain component is described as “including” or “having” another component, it means further including still another component rather than precluding other components unless especially stated otherwise.

In the present disclosure, the terms first, second, and the like are used only for the purpose of distinguishing one component from another component and do not limit the order or importance of the components unless specifically stated. Accordingly, within the scope of the present disclosure, a first component in one embodiment may be referred to as a second component in another embodiment, and likewise, a second component in one embodiment may be referred to as a first component in another embodiment.

In the present disclosure, components distinguished from each other are intended to clearly describe the characteristics of each and do not mean that the components are necessarily separated. That is, a plurality of components may be integrated and formed as a single hardware or software unit, and a single component may be distributed and formed as a plurality of hardware or software units. Accordingly, even when not mentioned separately, the embodiments in which the components are integrated or distributed are also included in the scope of the present disclosure.

In the present disclosure, components described in various embodiments do not necessarily mean essential components, and some may be optional components. Accordingly, an embodiment composed of a subset of components described in one embodiment is also included in the scope of the present disclosure. In addition, an embodiment including other components in addition to the components described in various embodiments is also included in the scope of the present disclosure.

In the present disclosure, each of phrases such as “A or B,” “at least one of A and B,” “at least one of A or B,” “A, B, or C,” “at least one of A, B, and C,” and “at least one of A, B, or C” may include one of items listed together in the corresponding phrase among these phrases or all possible combinations thereof.

Advantages and features of the present disclosure and methods for achieving them will become clear with reference to embodiments described below in detail in conjunction with the accompanying drawings. However, the present disclosure is not limited to the embodiments disclosed below but can be implemented in various different forms, these embodiments are merely provided to make the disclosure of the present disclosure complete and fully inform those skilled in the art to which the present disclosure pertains of the scope of the present disclosure.

In addition, in the present specification, the terms “part,” “device,” “system,” and the like may be intended to refer to hardware or a functional or structural combination of software driven by or for driving the hardware. For example, here, the hardware may be a data processing device including a central processing unit (CPU) or another processor. In addition, the software driven by the hardware may refer to a running process, an object, an executable, a thread of execution, a program, or the like.

In addition, in embodiments of the present disclosure, a gesture cue may refer to a technology which allows a driver to control various functions provided by a vehicle through a hand motion or a menu displayed to use the technology. By using the gesture cue technology, for example, the shape and movement of a hand may be recognized through a 3D camera sensor mounted near a center fascia or rearview mirror of a vehicle to perform a specific function corresponding to a gesture cue.

Hereinafter, specific technical contents to be implemented in the present disclosure will be described in detail with reference to the accompanying drawings.

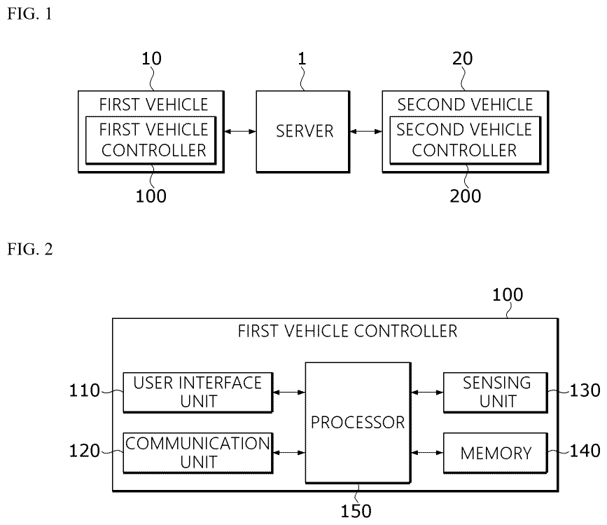

FIG. 1 is a view illustrating a vehicle control system according to an embodiment of the present disclosure.

Referring to FIG. 1, a vehicle control system may include a server 1, a first vehicle 10, and a second vehicle 20.

The server 1 may communicate with the first vehicle 10 or the second vehicle 20 to provide a connected car service. For example, the server 1 may store a gesture cue learning state for each profile of a passenger logging in the server 1 through the first vehicle 10 or the second vehicle 20.

The gesture cue learning state may include a cumulative number of ignition cycles (M, where M is a natural number greater than or equal to 1) or a cumulative number of cue uses (N, where N is a natural number greater than or equal to 1) of a passenger logging in using a first profile. The cumulative number (M) of ignition cycles is the number of times the ignition is turned on and off in at least one of the first vehicle 10 and the second vehicle 20. The cumulative number (N) of cue uses is the number of times a gesture cue is used in the first vehicle 10 and the second vehicle 20.

In the case of a plurality of gesture cues, the cumulative number (M) of ignition cycles and the cumulative number (N) of queue uses of the gesture cue learning state may be stored for each ID of the gesture cues. Accordingly, in the case of the plurality of gesture cues, one gesture cue learning state may be stored for one profile in the server 1, and one gesture cue learning state may include the cumulative number (M) of ignition cycles and the cumulative number (N) of queue uses for each ID of the gesture cues. The server 1 may transmit the gesture cue learning state including the cumulative number (M) of ignition cycles and the cumulative number (N) of queue uses for each ID of the gesture cues to the first vehicle 10 or a first vehicle controller 100.

Alternatively, the gesture cue learning state may further include whether a passenger is a beginner who has not mastered a use function of the gesture cue (i.e., has not completed learning) or a non-beginner who has mastered (i.e., has learned) for each ID of the gesture cues.

The first vehicle 10 and the second vehicle 20 may be connected to communicate with the server 1 and may provide a connected car service by communicating with the server 1.

In addition, the first vehicle controller 100 may be mounted on the first vehicle 10, and a second vehicle controller 200 may be mounted on the second vehicle 20.

The first vehicle controller 100 may be provided to be embedded around a center fascia in the first vehicle 10 and mounted in a movable or attachable/detachable type.

The second vehicle controller 200 may be provided to be embedded around a center fascia in the second vehicle 20 and mounted in a movable or attachable/detachable fashion.

In addition, the first vehicle controller 100 may be connected to communicate with the server 1. The first vehicle controller 100 may transmit the first profile, which is information about a passenger logging in the first vehicle 10, to the server 1 and receive a gesture cue learning state, which is stored after mapping with the first profile, from the server 1.

In addition, the first vehicle controller 100 may transmit the number of times the passenger uses a gesture cue or the number of ignition cycles to the server 1 after logging in the first vehicle 10. The server 1 may cumulatively store the number of times the gesture cue uses the gesture cue received from the first vehicle controller 100 or the number of times ignition is turned on in the first profile and update the gesture cue learning state. Since it is the same for the second vehicle 20, detailed description thereof will be omitted.

The first and second vehicle controllers 100 and 200 may be audio/video/navigation/telematics (AVNT) devices. The AVNT device may integrally perform audio, video, and navigation functions in a vehicle. The AVNT device may provide various functions such as a radio service which plays radio based on terrestrial radio signals, an audio service which plays a compact disc (CD), a video service which plays a digital video disk (DVD), a navigation service which provides route guidance services, a phone service which controls whether a mobile terminal connected to a vehicle receives a phone call, communication with other vehicles, and the like. In addition, unlike the conventional audio/video/navigation (AVN) device, the AVNT device communicates with an external server to allow a user to use various contents such as navigation updates, weather, music, news, and the like. The AVNT device may selectively display at least one of an audio screen, a video screen, and a navigation screen through a display device. The AVNT device may display an application screen downloaded through a user interface unit 110.

FIG. 2 is a block diagram illustrating the first vehicle controller 100 according to an embodiment of the present disclosure.

Referring to FIG. 2, the first vehicle controller 100 according to the embodiment of the present disclosure may include the user interface unit 110, a communication unit 120, a sensing unit 130, a memory 140, and a processor 150.

The user interface unit 110 provides an interfacing path for transmitting instructions or information between a user and the first vehicle controller 100 and displaying the result processed according to the instructions. The user interface unit 110 may include devices such as a mouse, a keyboard, a touch panel, a display panel, and the like.

The communication unit 120 may be communicatively connected to the server 1, a user terminal, or other in-vehicle controllers through a wired or wireless communication network or an internal cable. The wired/wireless communication network may include a communication network for performing wireless Internet communication such as a wireless LAN (WLAN), wireless broadband (WiBro), Wi-Fi, world interoperability for microwave access (WiMAX), high speed downlink packet access (HSDPA), a 3G communication function, 4G and 5G communication functions such as long term evolution (LTE), and the like.

The user terminal (not illustrated) is a portable terminal which may be linked with the first vehicle 10 or the second vehicle 20 and includes a smartphone, a smart wearable device, a tablet, a laptop computer, and the like.

In addition, the components illustrated in FIG. 2 may each transmit information through controller area network (CAN) communication, and the communication unit 120 may also provide the CAN communication.

The sensing unit 130 is a device for sensing a gesture of a passenger in a vehicle and may be implemented as a vision camera, an infrared sensor (IR sensor), an ultrasonic sensor, or the like. The sensing unit 130 may transmit a sensed gesture signal to the processor 150. The gesture of the passenger may include various actions such as hand gestures, body gestures, changes in facial expressions, and the like.

The memory 140 may store at least one program (e.g., an operating system, software, firmware, middleware, multiple applications, and the like), various types of data, and at least one command for controlling the first vehicle controller 100 and load the program, read or record data, or perform an operation corresponding to the instruction at the request of the processor 150.

The memory 140 may include at least one of storage media such as a random access memory (RAM), a static RAM (SRAM), a read only memory (ROM), a programmable ROM (PROM), an erasable PROM (EPROM), an electrically EPROM (EEPROM), a hard disk drive (HDD), a solid state disk (SSD), an embedded multimedia card (eMMC), a universal flash storage (UFS), and/or a web storage.

The program stored in the memory 140 may include a gesture cue control program. The gesture cue control program is a program for selectively displaying description of a gesture cue when the gesture cue, which is a menu which performs an operation according to a gesture of a passenger, is displayed on a screen. The gesture cue control program is a program which processes description of a gesture cue to be displayed next to a gesture cue which recognizes a gesture as an instruction in the case of a passenger in beginner mode of a vehicle. Accordingly, the passenger may recognize a gesture cue and learn a cue function through a gesture.

In addition, the memory 140 may store a gesture cue learning state for each profile of a passenger.

The processor 150 may perform overall control of the first vehicle controller 100 according to an input instruction. The instruction may be input to the processor 150 by the memory 140 or the user interface unit 110. For example, the processor 150 may execute a program or instruction stored in the memory 140 to control operations of the components (hardware or software) provided in the first vehicle controller 100 and perform data processing and calculation.

In addition, the processor 150 may load instructions or data received from another component (e.g., the user interface unit 110) into a volatile memory, process the instructions or data stored in the volatile memory, and store the result of the processing in a nonvolatile memory.

The processor 150 may include, for example, at least one of processing devices such as a CPU, a digital signal processor (DSP), an application specific integrated circuit (ASIC), a programmable logic device (PLD), a field programmable gate arrays (FPGA), a microcontroller, and/or a microprocessor.

In an embodiment of the present disclosure, when a passenger in the first vehicle 10 logs in using the first profile through a menu displayed on the user interface unit 110 or a user terminal (not illustrated), the processor 150 may determine whether to display description of a gesture cue based on a gesture cue learning state stored after mapping with the first profile. The processor 150 may receive the gesture cue learning state stored after mapping with the profile from the server 1 or check the gesture cue learning state from the memory 140. In an embodiment of the present disclosure, an operation of logging in the server 1 and then downloading a gesture cue learning state from the server 1 will be described as an example.

For example, when a passenger logs in by inputting the first profile, the processor 150 controls the communication unit 120 to transmit the input first profile to the server 1. When receiving a gesture cue learning status mapped to the first profile from the server 1, the processor 150 may check the received gesture cue learning state and determine a beginner mode for each gesture cue. The beginner mode is a mode determined when a passenger has no or little history of using a gesture cue. The received gesture cue learning state may include the cumulative number (M) of ignition cycles or the cumulative number (N) of cue uses of a passenger for each ID of gesture cues.

The processor 150 may check the received gesture cue learning state, and when it is confirmed that the passenger logging in using the first profile has not met a learning condition which is set for a first gesture cue, the processor 150 may determine that the passenger is in a beginner mode for the first gesture cue. The learning condition is that the cumulative number (M) of ignition cycles is greater than or equal to a minimum number of ignition cycles (M_{TH}), or the cumulative number (N) of cue uses is greater than or equal to a minimum number of cue uses (N_{TH}). The first gesture cue is, for example, one of a plurality of gesture cues provided by the first vehicle controller 100 through an AVNT menu and may be a gesture cue included in a screen to be currently displayed.

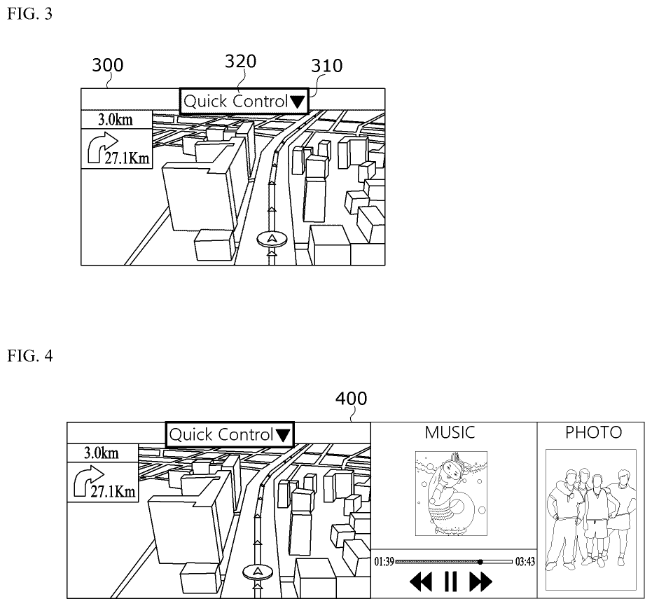

FIG. 3 is an exemplary view of a menu screen 300 on which a first gesture cue 310 and first description 320 are displayed.

Referring to FIG. 3, the processor 150 may process the menu screen 300 of FIG. 3 to be currently displayed on the user interface unit 110, and when it is determined that a mode is the beginner mode, process the AVNT menu, the first gesture cue 310, and the first description 320 (quick control) for the first gesture cue 310 to be displayed on the menu screen 300 together. The first description 320 for the first gesture cue 310 may be provided from the server 1 or stored in the memory 140. The first gesture cue 310 displayed with the first description 320 may be referred to as a first text cue, and the first gesture cue 310 with the first description 320 omitted may be referred to as a first default cue.

When a passenger recognizes that there is the first gesture cue 310 providing a hidden function by the first description 320 illustrated in FIG. 3 and makes a gesture near the first gesture cue 310 or clicks the first gesture cue 310, the processor 150 may display a screen 400 which further displays a menu or information corresponding to the first gesture cue 310 as illustrated in FIG. 4. FIG. 4 is an exemplary view of a screen on which a menu or information corresponding to the first gesture cue 310 is further displayed.

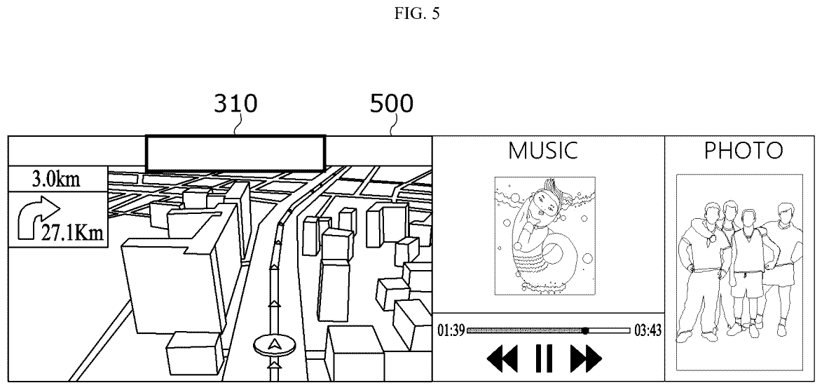

In addition, the processor 150 may count the number of times the passenger uses the first gesture cue 310 once, update the previously stored cumulative number (N) of cue uses, and then process the updated cumulative number (N) of cue uses to be stored in the memory 140 or transmitted to the server 1. Thereafter, when the passenger uses the first gesture cue 310 N_{TH} times or more, the processor 150 removes the first description 320 displayed on the menu screen 300 and stops the beginner mode. Accordingly, the processor 150 may process the menu screen 500 illustrated in FIG. 5 to be displayed on the user interface unit 110.

In addition, although not illustrated, the first gesture cue and a second gesture cue may be displayed on the menu screen 300, and it may be determined that the mode is the beginner mode for the first gesture cue and is in the non-beginner mode for the second gesture cue. In this case, the processor 150 may process the menu screen on which the text cue is displayed for the first gesture cue and the default cue is displayed for the second gesture cue to be displayed.

FIG. 5 is an exemplary view of the menu screen 500 on which the first gesture cue 310 is displayed in the case of no beginner mode. Referring to FIG. 5, the first description of the first gesture cue 310 is not displayed on the menu screen 500, and only the first gesture cue 310 is disposed thereon. That is, the first default cue is displayed. It means that it is determined that, since the passenger has completed learning the first gesture cue 310, thereafter, the passenger may recognize and use the first gesture cue 310.

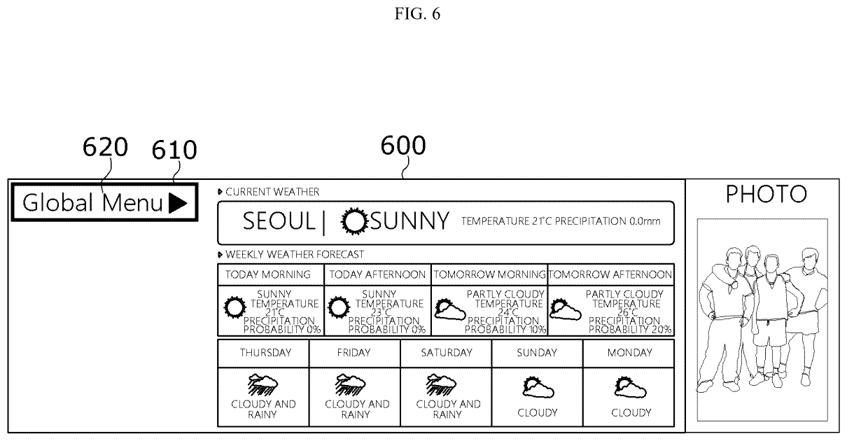

FIG. 6 is an exemplary view of a menu screen 600 on which a second gesture cue 610 and second description 620 are displayed.

The menu screen 600 illustrated in FIG. 6 is substantially the same as the menu screen 300 illustrated in FIG. 3. However, FIG. 6 illustrates that the second gesture cue 610 and the second description 620 for the second gesture cue 610 may be displayed at the left side of the menu screen 600.

Meanwhile, the processor 150 may check the gesture cue learning state received from the server 1 after the passenger inputs the first profile and logs in, and when it is confirmed that the passenger logging in using the first profile has met the learning condition which is set for the first gesture cue, the processor 150 may determine that the mode is not the beginner mode for the first gesture cue. Accordingly, as illustrated in FIG. 5, the processor 150 may process the menu screen 500 on which the first gesture cue 310 is displayed to be displayed.

In addition, when the passenger of the first vehicle 10 changes the first profile to a second profile and then logs in, the processor 150 may determine whether to display description of a gesture cue on the menu screen based on a gesture cue learning state stored after mapping with the second profile.

In addition, when the passenger of the first vehicle 10 logs in as a guest, the processor 150 may determine that the mode is the beginner mode and determine that all gesture cues with description of the gesture cues are displayed on the screen.

In addition, when the passenger of the second vehicle 20 gets on the first vehicle 10 and logs in using the second profile, the processor 150 may determine whether to display description of a gesture cue based on the gesture cue learning state stored after mapping with the second profile.

Likewise, when the passenger of the first vehicle 10 logs in using the first profile in the second vehicle 20, the second vehicle controller 200 of the second vehicle 20 may download the gesture cue learning state stored after mapping with the first profile from the server 1 and determine whether to display the description of the gesture cue based on the downloaded gesture cue learning state. Accordingly, the number (M) of ignition cycles or the number (N) of gesture cue uses mapped and stored for the first profile may be cumulatively stored in the server 1.

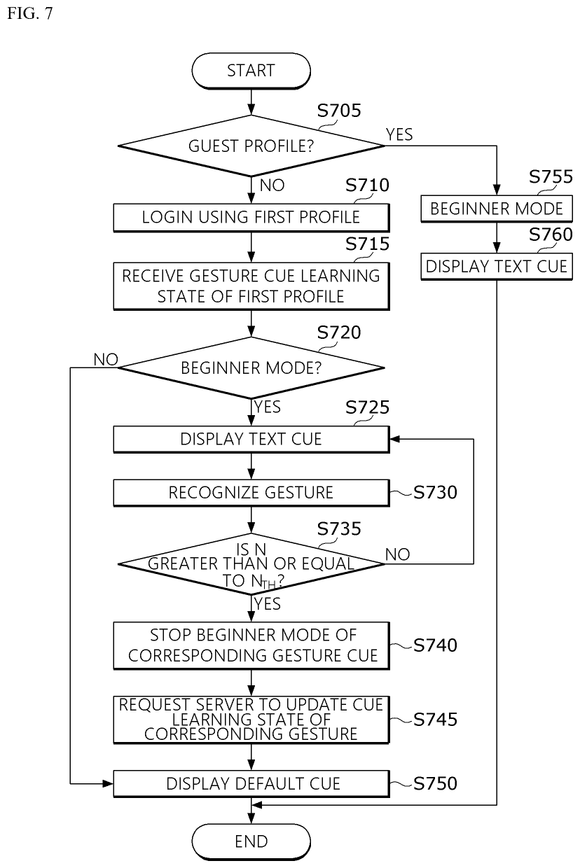

FIG. 7 is a flowchart illustrating a vehicle control method of the first vehicle controller 100 according to one embodiment of the present disclosure.

Referring to FIG. 7, when the passenger in the first vehicle 10 logs in using the first profile (No in S705 and S710), the first vehicle controller 100 transmits the first profile to the server 1 and receives the gesture cue learning state stored after mapping with the first profile from the server 1 (S715).

The first vehicle controller 100 may check the received gesture cue learning state and determine a beginner mode for each gesture cue (S720). For example, operation S720 may check the received gesture cue learning state, and when it is confirmed that the passenger logging in using the first profile has not met the learning condition which is set for the first gesture cue, the first vehicle controller 100 may determine that a mode is the beginner mode for the first gesture cue.

For example, when it is determined that the mode is the beginner mode for the first gesture cue (Yes in S720), the first vehicle controller 100 displays the first text cue on the menu screen 300 to be currently displayed (S725). That is, the first vehicle controller 100 displays the first gesture cue 310 along with the first description 320.

Thereafter, when the passenger makes a gesture corresponding to the first gesture cue 310 and the sensing unit 130 recognizes the gesture (S730), the first vehicle controller 100 updates the number (N) of times the passenger uses the first gesture cue 310, and when the updated cumulative number (N) of cue uses is N_{TH} times or more (Yes in S735), that is, when the learning condition is satisfied, the first vehicle controller 100 removes the first description 320 of the first gesture cue 310 from the menu screen 300 and stops the beginner mode (S740). Operation S735 only describes a case in which the cumulative number (N) of cue uses is compared with the N_{TH} times, but the first vehicle controller 100 may compare the cumulative number (M) of ignition cycles with M_{TH} or compare the number (N) of cue uses and the number (M) of ignition cycles with the N_{TH} and M_{TH} to determine whether to satisfy the learning condition.

In addition, the first vehicle controller 100 may transmit the cumulative number (N) of cue uses for the updated first gesture cue 310 to the server 1 and request the server 1 to update the first gesture cue learning state mapped to the first profile (S745). The first gesture cue learning state is the learning state of the first profile for the first gesture cue.

In addition, as illustrated in FIG. 5, the first vehicle controller 100 may process the menu screen 500 on which the default cue 310 is displayed to be displayed (S750).

Meanwhile, when the passenger logs in using a guest profile in operation S705 (Yes in S705), the first vehicle controller 100 may determine that a mode is the beginner mode (S755) and process the menu screen 300 including the text cue to be displayed (S760).

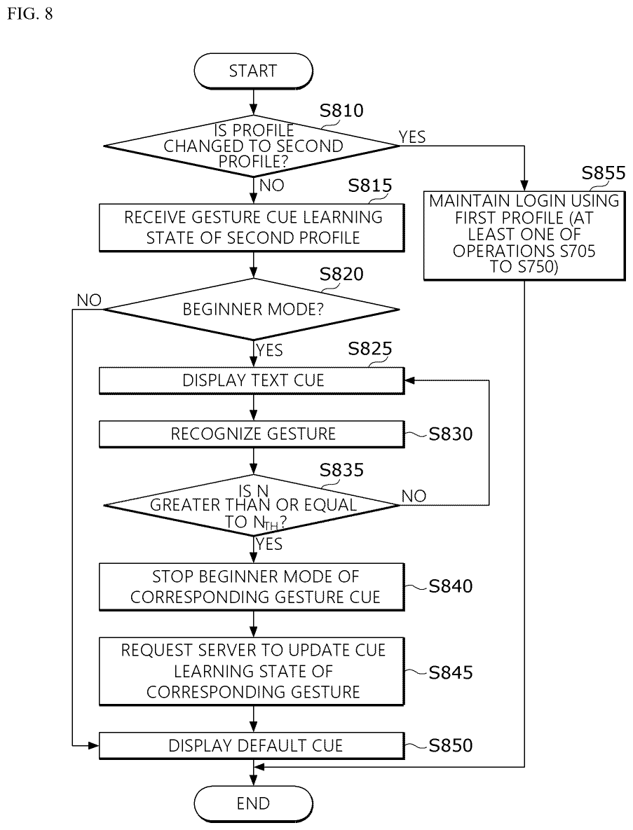

FIG. 8 is a flowchart illustrating a vehicle control method of the first vehicle controller 100 according to one embodiment of the present disclosure.

Referring to FIG. 8, when the passenger in the first vehicle 10 changes the profile from the first profile to the second profile and logs in (Yes in S810), the first vehicle controller 100 transmits the second profile to the server 1 and receives the gesture cue learning state stored after mapping with the second profile from the server 1 (S815).

The first vehicle controller 100 may check the received gesture cue learning state and determine whether a mode is the beginner mode for each gesture cue (S820).

For example, when it is determined that the mode is the beginner mode for the first gesture cue (Yes in S820), the first vehicle controller 100 displays the first text cue on the menu screen 300 to be currently displayed (S825). That is, the first vehicle controller 100 displays the first gesture cue 310 along with the first description 320.

Thereafter, when the passenger makes a gesture corresponding to the first gesture cue 310 and the sensing unit 130 recognizes the gesture (S830), the first vehicle controller 100 updates the number (N) of times the passenger uses the first gesture cue 310, and when the updated cumulative number (N) of cue uses is N_{TH} times or more (Yes in S835), the first vehicle controller 100 removes the first description 320 of the first gesture cue 310 from the menu screen 300 and stops the beginner mode (S840).

In addition, the first vehicle controller 100 may transmit the cumulative number (N) of cue uses for the updated first gesture cue 310 to the server 1 and request the server 1 to update the learning state corresponding to the first gesture cue learning state mapped to the second profile (S845).

In addition, as illustrated in FIG. 5, the first vehicle controller 100 may process the menu screen 500 on which the default cue 310 is displayed to be displayed (S850).

On the other hand, when the profile is not changed to the first profile in operation S810 (Yes in S810), the first vehicle controller 100 may perform at least one of operations S705 to S750 described in FIG. 7.

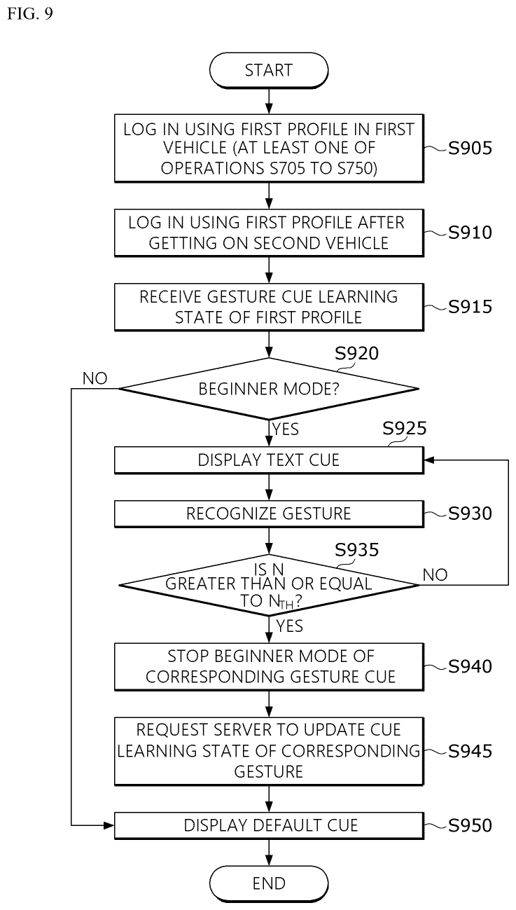

FIG. 9 is a flowchart illustrating a vehicle control method of the second vehicle controller 200 according to one embodiment of the present disclosure.

Referring to FIG. 9, while the passenger in the first vehicle 10 logs in using the first profile and the first vehicle controller 100 performs one of operations S705 to S750 (S905), the passenger may get off the first vehicle 10 and then get on the second vehicle 20 to log in using the first profile (S910).

The second vehicle controller 200 may transmit the first profile of the passenger in the second vehicle 20 to the server 1 and receive the gesture cue learning state, which is stored after mapping with the first profile, from the server 1.

The second vehicle controller 200 may check the received gesture cue learning state and determine whether a mode is the beginner mode for each gesture cue (S920).

When it is determined that the mode is the beginner mode (Yes in S920), the second vehicle controller 200 displays the first text cue on the menu screen 300 to be currently displayed (S925).

Thereafter, when the passenger makes a gesture corresponding to the first gesture cue 310 and the sensing unit 130 recognizes the gesture (S930), the second vehicle controller 200 updates the number (N) of times the passenger uses the first gesture cue 310, and when the updated cumulative number (N) of cue uses is N_{TH} times or more (Yes in S935), the second vehicle controller 200 removes the first description 320 of the first gesture cue 310 from the menu screen 300 and stops the beginner mode (S940).

In addition, the second vehicle controller 200 may transmit the cumulative number (N) of cue uses for the updated first gesture cue 310 to the server 1 and request the server 1 to update the learning state corresponding to the first gesture cue learning state mapped to the second profile (S945).

In addition, as illustrated in FIG. 5, the second vehicle controller 200 may process the menu screen 500 on which the default cue 310 is displayed (S950).

Various embodiments of the present disclosure do not list all possible combinations but are intended to describe representative aspects of the present disclosure, and the matters described in the various embodiments may be applied independently or in combination of two or more.

In addition, various embodiments of the present disclosure may be implemented by hardware, firmware, software, or a combination thereof. When various embodiments are implementation by hardware, various embodiments may be implemented by one or more ASICs, DSPs, digital signal processing devices (DSPDs), PLDs, FPGAs, general processors, controllers, microcontrollers, microprocessors, or the like.

According to the present disclosure, it is possible to display both a gesture cue, which is executed based on a gesture, and description of a cue so that a user can easily recognize and use the gesture cue. Accordingly, the description of the gesture cue can be additionally displayed before a driver actually uses the gesture cue so that the driver recognizes the gesture cue and uses various hidden functions provided by the gesture cue.

In addition, according to the present disclosure, by displaying a text cue displayed with the description of the gesture cue, the driver can recognize a function indicated by the corresponding cue even before performing a gesture.

In addition, according to the present disclosure, when it is determined that the driver has sufficiently learned the gesture cue, it is possible to more simply display a screen by not displaying the description of the gesture cue.

In addition, conventionally, when a driver changes a profile, the driver cannot use the corresponding function by displaying a gesture cue without learning a gesture, but according to the present disclosure, the gesture cue or the description of the gesture cue can be displayed in conjunction with the changed profile.

In addition, according to the present disclosure, upon logging in vehicle B with a profile which has been learned completely in vehicle A through a profile stored in a server, learning on the gesture cue has been already completed, and thus a simple default cue can be displayed in vehicle B.

In addition, according to the present disclosure, it is possible to enhance user convenience by separately displaying a text cue (i.e., a beginner mode) or a default cue (i.e., a beginner mode off) depending on whether a driver completes learning on a gesture cue.

Effects obtainable from the present disclosure are not limited to the above-described effects, and other effects that are not mentioned will be able to be clearly understood by those skilled in the art to which the present disclosure pertains from the following description.

The scope of the present disclosure includes software or machine-executable instructions (e.g., an operating system, an application, firmware, a program, and the like) which cause operations according to methods of various embodiments to be executed on a device or a computer, and a non-transitory computer-readable medium in which such software or instructions are stored and which is executable on the device or the computer.

While the present disclosure has been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

What is claimed is:

1. A vehicle controller comprising:
a user interface unit configured to display a menu screen including a plurality of menus and at least one gesture cue;
a memory configured to store one or more programs; and
a processor configured to execute the one or more programs;
wherein, when a passenger in a first vehicle logs in using a first profile, the processor is configured to determine whether to display a description for the at least one gesture cue based on a gesture cue learning state stored after mapping with the first profile.

2. The vehicle controller of claim 1, wherein, when checking the gesture cue learning state and determining that a mode is a beginner mode, the processor is configured to determine that the description of the at least one gesture cue is displayed with the at least one gesture cue on the menu screen.

3. The vehicle controller of claim 2, wherein, when checking the gesture cue learning state and determining that the passenger logging in using the first profile has not met a learning condition which is set for the at least one gesture cue, the processor is configured to determine that the mode is the beginner mode.

4. The vehicle controller of claim 2, wherein, when the passenger uses the at least one gesture cue N_{TH} times or more, where N_{TH} is a natural number greater than or equal to 1, the processor is configured to remove the description of the at least one gesture cue displayed on the menu screen, and to stop the beginner mode.

5. The vehicle controller of claim 1, wherein, when checking the gesture cue learning state and determining that a mode is not a beginner mode, the processor is configured to determine that the at least one gesture cue without a description is displayed on the menu screen.

6. The vehicle controller of claim 5, wherein, when checking the gesture cue learning state and determining that the passenger logging in using the first profile has met a learning condition which is set for the gesture cues, the processor is configured to determine that the mode is not the beginner mode.

7. The vehicle controller of claim 1, wherein, when the passenger in the first vehicle logs in using a second profile, the processor is configured to determine whether to display the description of the at least one gesture cue based on a gesture cue learning state stored after mapping with the second profile.

8. The vehicle controller of claim 1, wherein, when the passenger logs in using the first profile in a second vehicle, the second vehicle is configured to determine whether to display the description of the at least one gesture cue based on the gesture cue learning state stored after mapping with the first profile.

9. The vehicle controller of claim 1, wherein the processor is configured to download the gesture cue learning state from a server.

10. The vehicle controller of claim 1, wherein the at least one gesture cue comprises a first gesture cue positioned on a first side of the menu screen and a second gesture cue positioned on a second side of the menu screen.

11. A vehicle control method of a vehicle controller including a user interface unit, a memory configured to store one or more programs, and a processor configured to execute the one or more programs, the vehicle control method comprising:
logging in, by a passenger in a first vehicle, using a first profile;
determining, by the processor, whether to display a description of a plurality of gesture cues based on a gesture cue learning state stored after mapping with the first profile; and
displaying, on a user interface, a menu screen including a plurality of menus and the plurality of gesture cues; and
displaying, on the user interface, the description of the plurality of gesture cues.

12. The vehicle control method of claim 11, wherein, in the determining of whether to display the description of the plurality of gesture cues, when the gesture cue learning state is confirmed and it is determined that a mode is a beginner mode, the processor determines that the description of the plurality of gesture cues is displayed with the plurality of gesture cues on the menu screen.

13. The vehicle control method of claim 12, wherein, in the determining of whether to display the description of the plurality of gesture cues, when the gesture cue learning state is confirmed and it is determined that the passenger logging in using the first profile has not met a learning condition which is set for the plurality of gesture cues, the processor determines that the mode is the beginner mode.

14. The vehicle control method of claim 12, further comprising removing the description of the plurality of gesture cues displayed on the menu screen, and stopping the beginner mode when the passenger uses the plurality of gesture cues N_{TH} times or more, where N_{TH} is a natural number greater than or equal to 1.

15. The vehicle control method of claim 11, wherein, in the determining of whether to display the description of the plurality of gesture cues, when the gesture cue learning state is confirmed and it is determined that a mode is not a beginner mode, the processor determines that the plurality of gesture cues without the description are displayed on the menu screen.

16. The vehicle control method of claim 15, wherein, in the determining of whether to display the description of the plurality of gesture cues, when the gesture cue learning state is confirmed and it is determined that the passenger logging in using the first profile has met a learning condition which is set for the plurality of gesture cues, the processor determines that the mode is not the beginner mode.

17. The vehicle control method of claim 11, further comprising determining whether to display the description of the plurality of gesture cues based on a gesture cue learning state stored after mapping with a second profile when the passenger in the first vehicle logs in using a second profile.

18. The vehicle control method of claim 11, wherein, when the passenger logs in using the first profile in a second vehicle, the second vehicle determines whether to display the description of the plurality of gesture cues based on the gesture cue learning state stored after mapping with the first profile.

19. The vehicle control method of claim 11, further comprising downloading the gesture cue learning state from a server.

20. The vehicle control method of claim 11, wherein the plurality of gesture cues comprise a first gesture cue positioned on a first side of the menu screen and a second gesture cue positioned on a second side of the menu screen.
